(19) United States
(12) Patent Application Publication
(10) Pub. No.: US 2009/0125550 A1
(43) Pub. Date: May 14, 2009

(54) TEMPORAL EVENT STREAM MODEL

(75) Inventors: Roger S. Barga, Bellevue, WA (US); Jonathan D. Goldstein, Kirkland, WA (US); Mohamed Ali, Bellevue, WA (US); Mingsheng Hong, Ithaca, NY (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/937,011

(22) Filed: Nov. 8, 2007

(51) Int. Cl. G06F 7/00

(52) U.S. Cl. 707/104.1; 707/E17.009

(57) ABSTRACT

Disclosed is a temporal stream model that provides support both for query language semantics and consistency guarantees, simultaneously. A data stream is modeled as a time varying relation. The data stream model incorporates a temporal data perspective, and defines a clear separation in different notions of time in streaming applications. The temporal stream model further refines the conventional application time into two temporal dimensions of valid time and occurrence time, and utilizes system time (the clock of the stream processor) for modeling out-of-order event delivery but thereby providing three temporal dimensions. The methods for assigning timestamps and quantifying latency form the basis for defining a spectrum of consistency levels. Based on the selected consistency level, an output can be produced. The utilization of system time facilitates the retraction of incorrect output and the insertion of the correct revised output.

### BACKGROUND

Most businesses today actively monitor data streams and application messages in order to detect business events or situations and take time-critical actions. It is not an exaggeration to say that business events are the real drivers of the enterprise today because these events represent changes in the state of the business. Unfortunately, as in the case of data management in pre-database days, every usage area of business events today tends to build its own special purpose infrastructure to filter, process, and propagate events.

Designing efficient, scalable infrastructure for monitoring and processing events has been a major research interest in recent years. Various technologies have been proposed, including data stream management, complex event processing, and asynchronous messaging such as publish/subscribe. These systems share a common processing model, but differ in query language features. Furthermore, applications may have different requirements for consistency, which specifies the desired tradeoff between insensitivity to event arrival order and system performance. Some applications require a strict notion of correctness that is robust relative to event arrival order, while other applications are more concerned with high throughput. If exposed to the user and handled within the system, users can specify consistency requirements on a per query basis and the system can adjust consistency at runtime to uphold the guarantee and manage system resources.

To illustrate, consider a financial services organization that actively monitors financial markets, individual trader activity and customer accounts. An application running on a trader's desktop may track a moving average of the value of an investment portfolio. This moving average needs to be updated continuously as stock updates arrive and trades are confirmed, but does not require perfect accuracy. A second application running on the trading floor extracts events from live news feeds and correlates these events with market indicators to infer market sentiment, impacting automated stock trading programs. This query looks for patterns of events, correlated across time and data values, where each event has a short “shelf life”. In order to be actionable, the query must identify a trading opportunity as soon as possible with the information available at that time; late events may result in a retraction. A third application running in the compliance office monitors trader activity and customer accounts to watch for churn and ensure conformity with rules and institution guidelines. These queries can run until the end of a trading session or perhaps longer, and must process all events in proper order to make an accurate assessment. These applications carry out similar computations but differ significantly in workload and requirements for consistency guarantees and response time.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Disclosed is a temporal stream model that provides support both for query language semantics and consistency guarantees, simultaneously. A data stream is modeled as a time varying relation. The data stream model incorporates a temporal data perspective, and defines a clear separation in different notions of time in streaming applications. This facilitates reasoning about causality across event sources and latency in transmitting events from the point of origin to the processing node.

The temporal stream model utilizes system time (the clock of the stream processor) for modeling out-of-order event delivery but further refines the conventional application time into two temporal dimensions of valid time and occurrence time, thereby providing three temporal dimensions.

Each tuple in the time varying relation is an event, and each event has an identifier (ID). Each tuple has a validity interval, which indicates the range of time when the tuple is valid from the perspective of the event provider (or source). After an event initially appears in the stream, the event validity interval can be changed by the event provider. The changes are represented by tuples with the same ID but different content. The occurrence time also models when the changes occur from the perspective of the event provider.

The methods for assigning timestamps and quantifying latency form the basis for defining a spectrum of consistency levels. Based on the selected consistency level, an output can be produced. The utilization of system time facilitates the retraction of incorrect output and the insertion of the correct revised output.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a computer-implemented event processing system.

FIG. 2 illustrates application of the temporal model of event handling in a data acquisition system.

FIG. 3 illustrates an exemplary bitemporal history table employed for consistency streaming according to a bitemporal model.

FIG. 4 illustrates a tritemporal history table employed for consistency streaming according to a tritemporal model.

FIG. 5 illustrates a query language for registering event queries.

FIG. 6 illustrates a process for converting a non-canonical history table into canonical form.

FIG. 7 illustrates a computer-implemented method of events processing.

FIG. 8 illustrates a method of registering an event query.

FIG. 9 illustrates a method of correcting incorrect output.

FIG. 10 illustrates a method of defining levels of consistency for query processing.

FIG. 11 illustrates a block diagram of a computing system operable to execute event stream processing in accordance with the disclosed architecture.

FIG. 12 illustrates a schematic block diagram of an exemplary computing environment for consistent event stream processing.

### DETAILED DESCRIPTION

Event processing will play an increasingly important role in constructing enterprise applications that can immediately react to business critical events. Conventional data stream systems, which support sliding window operations and use sampling or approximation to cope with unbounded streams, could be used to compute a moving average of portfolio values. However, there are significant features that cannot be naturally supported in existing stream systems. First, instance selection and consumption can be used to customize output and increase system efficiency, where selection specifies which event instances will be involved in producing output, and consumption specifies which instances will never be involved in producing future output, and therefore can be effectively “consumed”. Without this feature, an operator such as sequence is likely to be too expensive to implement in a stream setting—no past input can be forgotten due to its potential relevance to future output, and the size of output stream can be multiplicative with respect to the size of the input.

Expressing negation or the non-occurrence of events (e.g., a customer not answering an email within a specified time) in a query is useful for many applications, but can not be naturally expressed in many existing stream systems. Messaging systems such as pub/sub could handily route news feeds and market data but pub/sub queries are usually stateless and lack the ability to carry out computation other than filtering.

Complex event processing systems can detect patterns in event streams, including both the occurrence and non-occurrence of events, and queries can specify intricate temporal constraints. However, most conventional event systems provide only limited support for value constraints or correlation (predicates on event attribute values), as well as query directed instance selection and consumption policies. Finally, none of the above technologies provide support for consistency guarantees.

The disclosed architecture integrates conventional technologies associated with data stream management, complex event processing, and asynchronous messaging (e.g., publish/subscribe) as an event streaming system that embraces a temporal stream model to unify and further enrich query language features, handle imperfections in event delivery, and define correctness guarantees. Disclosed herein is a paradigm that integrates and extends these models, and upholds precise notions of consistency.

A system referred to herein as CEDR (Complex Event Detection and Response) is used to explore the benefits of an event streaming system that integrates the above technologies, and supports a spectrum of consistency guarantees. As will be described in greater detail herein, the CEDR system includes a stream data model that embraces a temporal data perspective, and introduces a clear separation of different notions of time in streaming applications. A declarative query language is disclosed that is capable of expressing a wide range of event patterns with temporal and value correlation, negation, along with query directed instance selection and consumption. All aspects of the language are fully composable.

Along with the language, a set of logical operators is defined that implement the query language and serve as the basis for logical plan exploration during query optimization. The correctness of an implementation is based on view update semantics, which provides an intuitive argument for the correctness of the consistency results in our system. Additionally, a spectrum of consistency levels is defined to deal with stream imperfections, such as latency or out-of-order delivery, and to meet application requirements for quality of the result. The consequences of upholding the consistency guarantees in a streaming system are also described.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

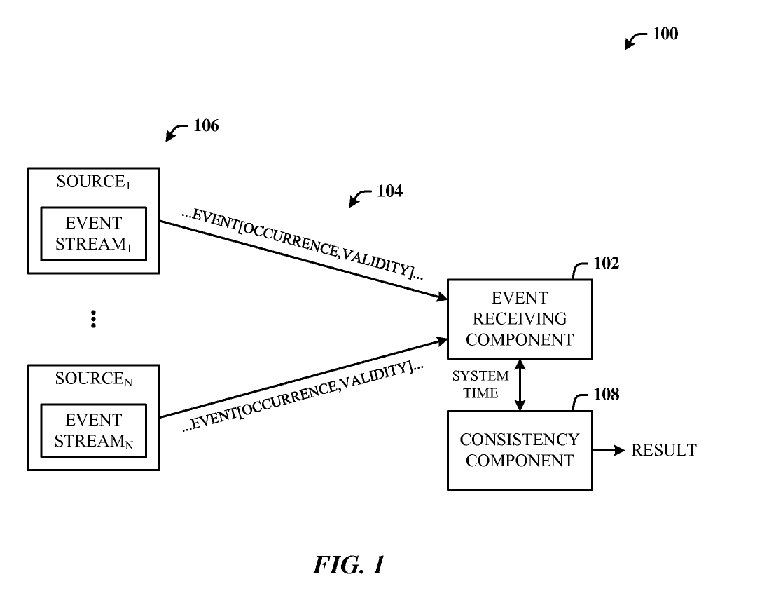

FIG. 1 illustrates a computer-implemented event processing system 100. The system 100 includes an event receiving component 102 for receiving events 104 (denoted . . . EVENT . . . ) as event streams (denoted EVENT STREAM₁, . . . ,EVENT STREAM_{N}) from corresponding streaming sources 106 (denoted SOURCE₁, . . . ,SOURCE_{N}), the events 104 tagged with occurrence information (denoted OCCURRENCE) and validity information (denoted VALIDITY). The sources 106 can be applications operating independently and responding separately to a query for data, for example, from a single device or different devices. The sources can also be separate devices from which the event stream is sent to the event receiving component 102.

The system 100 also includes a consistency component 108 for processing the occurrence information (a first temporal entity) and validity information (a second temporal entity) of the events 104 to guarantee consistency in a result (or output). When the events 104 are received at the receiving component 102, each event can be further associated with system time (a third temporal entity). The consistency component 108 processes the occurrence information (e.g., time), validity information (e.g., time), and system time to provide a consistent output that may be requested from a query for data.

In other words, there is a source of the event, the generator of the event, and the actual receiver of the event each of which is distinguished temporally according to a tritemporal model. Based on the model, the system 100 facilitates the ability to reason about events at a time that the events took place. The sources 106 can be on different websites and running on different clocks. Using the additional time information (e.g., occurrence, validity) provides a basis for reasoning about event causality. The senders (sources 106) of the events timestamp the events based on a local clock, which indicates the time the event occurred relative to the source.

The sender also assigns (or tags to) a validity interval (validity information) to each event. The occurrence time is the time in which the event occurred at the sender and the validity interval time is the period of time during which the event is believed to hold true. The sender (or the poster) of the event tags these two timestamps on the event and then sends the tagged events 104 over a network (e.g., the Internet) to the receiving component 102 that analyzes the events arriving from the distinct sources 106.

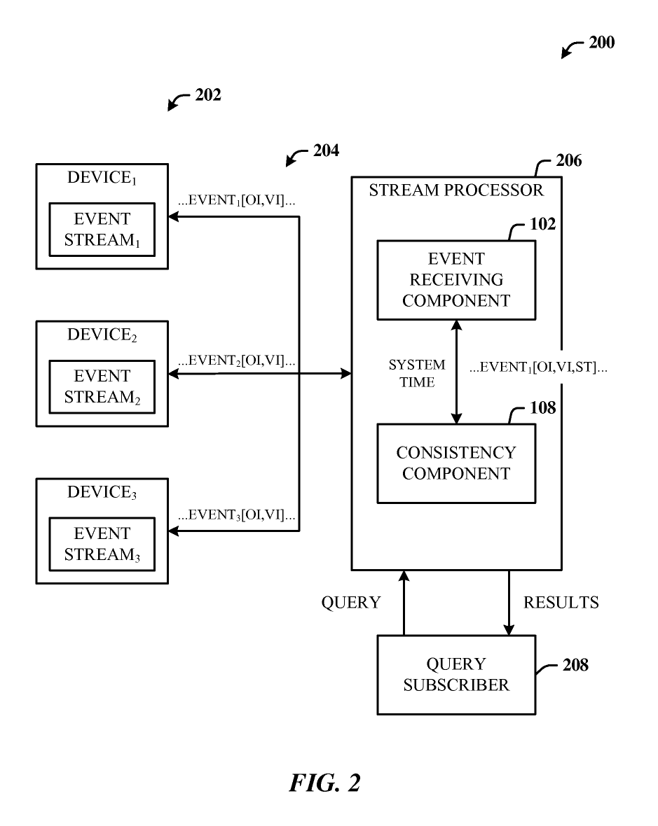

FIG. 2 illustrates application of the temporal model of event handling in a data acquisition system (DAS) 200. In an exemplary data acquisition application, three sensor devices 202 are employed to send data (events) about certain system conditions (e.g., temperature, humidity, flow rate, etc.). The devices 202 can send streaming event data 204 to a stream processor 206 of the DAS 200, the stream processor 206 illustrated as including the event receiving component 102 and the consistency component 108. Here, the devices 202 timestamp the events (EVENT₁, EVENT₂, and EVENT₃) of the respective event streams (denoted EVENT STREAM₁, EVENT STREAM₂, and EVENT STREAM₃) with the occurrence information (OI) and validity information (VI) before transmission to the stream processor 206.

The stream processor 206 receives and processes the streaming event data 204 in response to a query from a subscriber 208 by adding system time (ST) of the stream processor 206 to the event timestamp information (OI and VI) (now denoted as EVENT[OI,VI,ST]). For example, a temperature sensor (e.g., DEVICE₁) configured to measure temperature, timestamps the temperature data with the OI and VI, and sends the timestamped temperature data every one-tenth of a second in a continuous manner. A query from the subscriber 208 to the stream processor 206 can be in the form of a query language such as “compute a moving average of the temperature in a 1-second window”. The processor 206 will than take ten of the temperature readings, and average the readings every one-tenth of a second over a new set of ten measurements.

Given that the event data 204 can arrive at the stream processor 206 out of order, the stream processor 206 processes the event data 204 to guarantee consistency in the output by honoring the ordering expressed by the timestamps (OI and VI) and further facilitated by the system time (ST). The consistency component 108 uses a technique referred to as retraction. Retractions are a way of performing speculative execution. The processor 206 can issue output based on what the processor 206 knows at any given time. If that output turns out to be incorrect, the processor 206 can retract individual pieces of data 204 that was sent, and then resend the correct information. This is described in greater detail herein.

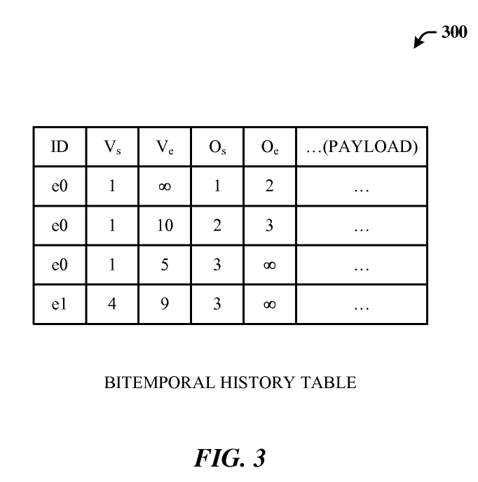

FIG. 3 illustrates an exemplary bitemporal history table 300 employed for consistency streaming according to a bitemporal model. The model is the theoretical foundation for CEDR which supports both query language semantics and consistency guarantees simultaneously. Conventional stream systems separate the notion of application time and system time, where the application time is the clock that event providers (sources) use to timestamp generated tuples, and system time is the clock of the stream processor. In CEDR, the application time is further refined into two temporal dimensions: a first dimension of occurrence time and a second dimension of valid time. Additionally, a third dimension of system time is referred to as CEDR time. This provides three temporal dimensions in the stream temporal model.

In CEDR, a data stream is modeled as a time-varying relation. Each tuple in the relation is an event, and has an event identifier (ID). Each tuple has a validity interval, which indicates the range of time when the tuple is valid from the perspective of the event provider's (or source). Given the interval representation of each event, it is possible to issue the following continuous query: “at each time instance t, return all tuples that are still valid at time t.” Note that conventional systems model stream tuples as points, and therefore, do not capture the notion of validity interval. Consequently, conventional systems cannot naturally express such a query, and although an interval can be encoded with a pair of points, the resulting query formulation will be unintuitive.

After an event initially appears in the stream, the event validity interval (e.g., the time during which a coupon could be used) can be changed by the event provider (source), a feature not known to be supported in conventional stream systems. The changes are represented by tuples with the same ID, but different content. The second temporal dimension of occurrence time models when the changes occur from the event provider's perspective.

An insert event of a certain ID is the tuple with minimum occurrence start time value (Oₛ) among all events with that ID. Other events with the same ID are referred to as modification events. Both valid time and occurrence time are assigned by the same logical clock of the event provider, and are thus comparable. Valid time and occurrence time can be assigned by different physical clocks, which can then be synchronized.

Valid time is denoted tᵥ and occurrence time is denoted tₒ. The following schema is employed as a conceptual representation of a stream produced by an event provider: (ID, Vₛ, Vₑ, Oₛ, Oₑ, Payload). Here, Vₛ and Vₑ correspond to valid start time and valid end time; Oₛ and Oₑ correspond to occurrence start time and occurrence end time; and, Payload is a sub-schema that includes normal value attributes and is application dependent.

For example, the bitemporal table 300 represents the following scenario: at time 1, event e0 is inserted into the stream with validity interval [1, ∞); at time 2, e0's validity interval is modified to [1, 10); at time 3, e0's validity interval is modified to [1, 5), and e1 is inserted with validity interval [4, 9). Note that the content of payload in all examples throughout this description is ignored such that the focus is on the temporal attributes.

The above bitemporal schema is a conceptual representation of a stream. In an actual implementation, stream schemas can be customized to fit application scenarios.

When events produced by the event provider are delivered into the CEDR system, the events can become out of order due to unreliable network protocols, system crash recovery, and other anomalies in the physical world. Out-of-order event delivery is modeled with the third temporal dimension producing a tritemporal stream model.

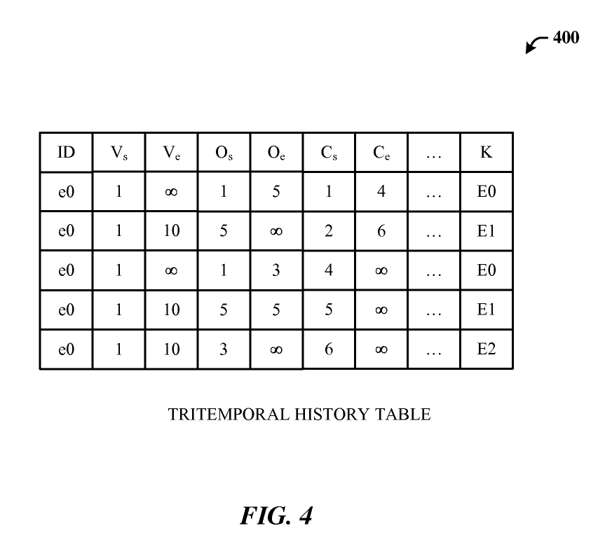

FIG. 4 illustrates a tritemporal history table 400 employed for consistency streaming according to a tritemporal model. As previously indicated, due to unreliable network connections, stream events and the associated state changes may be delivered in non-deterministic order. In such situations, it is undesirable to block until all the early data has provably arrived. Nevertheless, output can be produced by retracting incorrect output and add the correct revised output. The ability to model and handle such retractions and insertions is a distinguishing feature of CEDR. This is modeled by moving to a tritemporal model, which adds a third notion of time, called CEDR time, denoted T.

Note that in the tritemporal table 400, valid time and occurrence time fields are used. In addition, a new set of fields associated with CEDR time are employed. These new fields use the clock associated with a CEDR stream. In particular, Cₛ corresponds to the CEDR server clock start time upon event arrival. While used for supporting retraction, CEDR time also reflects out-of-order delivery of data. Finally, note that there is a K column, where each unique value in the K column corresponds to an initial insert and all associated retractions, each of which reduces the server clock end time Cₑ compared to the previous matching entry in the table.

The tritemporal table 400 models both a retraction and a modification simultaneously, and may be interpreted as follows. At CEDR time 1, an event arrives where valid time is [1,∞), and has occurrence time 1. At CEDR time 2, another event arrives which states that the first event's valid time changes at occurrence time 5 to [1,10). Unfortunately, the point in time where the valid time changed was incorrect. Instead, the valid time should have changed at occurrence time 3.

This is corrected by the following three events on the stream. The event at CEDR time 4 changes the occurrence end time for the first event from 5 to 3. Since retractions can only decrease Oₑ, the original E1 event is completely removed so that a new event with a new Oₛ time can be inserted. Thus, the old event is completely removed from the system by setting Oₑ to Oₛ. A new event, E2, is then inserted with occurrence time [3, ∞) and valid time [1,10).

Note that the net effect is that at CEDR time 3, the stream, in terms of valid time and occurrence time, contains two events: an insert and a modification that changes the valid time at occurrence time 5. At CEDR time 7, the stream describes the same valid time change, except at occurrence time 3, rather than at 5. Note that these retractions can be characterized and described using only occurrence time and CEDR time.

An expressive, declarative language is needed to define queries for complex event processing. Complex event queries like this can address both occurrences and non-occurrences of events, and impose temporal constraints (e.g., order of event occurrences and sliding windows) as well as value-based constraints over these events. Publish/subscribe systems focus mostly on subject or predicate-based filters over individual events. Languages for stream processing lack constructs to address non-occurrences of events and become unwieldy for specifying complex event order-oriented constraints. Event languages developed for active database systems lack support for sliding windows and value-based comparisons between events.

In CEDR language, existing language constructs from the above communities are leveraged and significant extensions are developed to address the requirements of a wide range of monitoring applications.

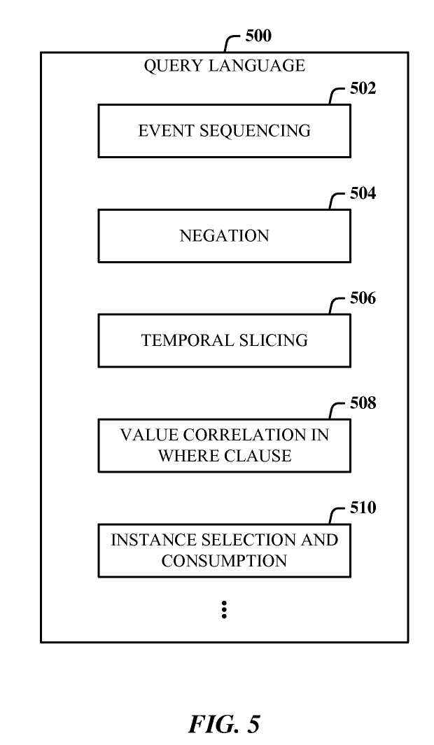

FIG. 5 illustrates a query language 500 for registering event queries. CEDR query semantics are defined on the information obtained from event providers, which implies the query language reasons about valid and occurrence time, but not CEDR time. When specifying the semantics of a CEDR query, the query input and output are both bitemporal streams (of valid time and occurrence time).

The CEDR language 500 for registering event queries is based on the following three aspects: 1) event pattern expression, composed by a set of high level operators that specify how individual events are filtered, and how multiple events are correlated (joined) via time-based and value-based constraints to form composite event instances, or instances for short; 2) instance selection and consumption, expressed by a policy referred to as an SC mode; and, 3) instance transformation, which takes the events participating in a detected pattern as input, and transforms the events to produce complex output events via mechanisms such as aggregation, attribute projection, and computation of a new function.

Following is an overview of the CEDR language 500 syntax and semantics, and definitions the formal semantics from the above three aspects. The overall structure of the CEDR language 500 is:

EVENT <name string>
WHEN <expression composed by event types, operators and SC modes>
[WHERE < correlation predicates/constraints>]
[OUTPUT <instance transformation conditions>]

Event pattern expression for filtering and correlation are specified in WHEN and WHERE clauses, where temporal constraints are specified by operators in the WHEN clause, and value-based constraints (i.e., constraints on attributes in event payloads) are specified in WHERE clause. In general, the WHERE clause can be a Boolean combination (using logical connectives AND and OR) of predicates that use one of the six comparison operators (=, ≠, >, <, ≧, ≦). Here is an example.

EVENT UPDATE_MACHINE
WHEN INSTALL
WHERE software_type = ‘SP’ AND version_id = ‘2’

A second example illustrates the use of a few operators in the WHEN clause, and the notion of operator scopes. The query detects a failed software upgrade by reporting that an upgrade was installed on the machine and then the machine was shut down within twelve hours, without a subsequent restart event within five minutes after the shutdown event happens. The formulation is given below.

EVENT FAILED_UPGRADE
WHEN UNLESS(SEQUENCE(INSTALL AS x, SHUTDOWN AS y,
12 hours),
RESTART AS z, 5 minutes)
WHERE x.Machine_Id = y.Machine_Id AND x.Machine_Id =
z.Machine_Id
/* or equivalently, CorrelationKey[Machine_Id , Equal] */

A SEQUENCE construct specifies a sequence of events in a particular order. The parameters of the SEQUENCE operator (or any operator that produces composite events in general) are the occurrences of events of interest, referred to as contributors. There is a scope associated with the sequence operator, which puts an upper bound on the temporal distance between the occurrence of the last contributor in the sequence and that of the first contributor.

In this query, the SEQUENCE construct specifies a sequence that consists of the occurrence of an INSTALL event followed by a SHUTDOWN event, within twelve hours of the occurrence of the former. The output of the SEQUENCE construct can then be followed by the non-occurrence of a RESTART event within five minutes. Non-occurrences of events, also referred to as negation, can be expressed either directly using the NOT operator, or indirectly using UNLESS operator, which is used in this query formulation.

Intuitively, UNLESS(A, B, w) produces an output when the occurrence of an A event is followed by non-occurrence of any B event in the following w time units; w is therefore the negation scope. The UNLESS operator is used in this query to express that the sequence of INSTALL, SHUTDOWN events can be followed by no RESTART event in the next five minutes. A sub-expression can be bound to a variable via an AS construct, such that reference can be made to the corresponding contributor in WHERE clause when specifying value constraints.

The following describes the WHERE clause for this query. The variables defined previously are used to form predicates that compare attributes of different events. To distinguish from simple predicates that compare to a constant such as those in the first example, such predicates are referred to as parameterized predicates as the attribute of the later event addressed in the predicate is compared to a value that an earlier event provides. The parameterized predicates in this query compare the Id attributes of all three events in the WHEN clause for equality. Equality comparisons on a common attribute across multiple contributors are typical in monitoring applications.

For ease of exposition, the common attribute used for this purpose is referred to as a correlation key, and the set of equality comparisons on this attribute are referred to as an equivalence test. The CEDR language 500 provides a shorthand notation: an equivalence test on an attribute (e.g., Machine_Id) can be simply expressed by enclosing the attribute name as an argument to the function CorrelationKey with one of the keywords EQUAL, UNIQUE (e.g., CorrelationKey(Machine_ID, Equal), as shown in the comment on the WHERE clause in this example). Moreover, if an equivalence test further requires all events to have a specific value (e.g., ‘BARGA_XP03’) for the attribute Id, this can be expressed as [Machine_Id Equal ‘BARGA_XP03’].

Instance selection and consumption are specified in the WHEN clause as well. Finally, instance transformation is specified in an optional OUTPUT clause to produce output events. If the OUTPUT clause is not specified in a query, all instances that pass the instance selection process will be output directly to the user.

Following are features that distinguish the query language 500 from other event processing and data stream languages.

Event Sequencing 502. Event sequencing is the ability to synthesize events based upon the ordering of previous events is a basic and powerful event language construct. For efficient implementation in a stream setting, all operators that produce outputs involving more than one input event have a time-based scope, denoted as w. For example, SEQUENCE(E1, E2, w) outputs a sequence event at the occurrence of an E2 event, if there has been an E1 event occurrence in the last w time units. In CEDR, scope is “tightly coupled” with operator definition, and thus, helps users in writing properly scoped queries, and permits the optimizer to generate efficient plans.

Negation 504. The event service can track the non-occurrence of an expected event, such as a customer not answering an email within a specified time. Negation has a scope within which the non-occurrence of events is monitored. The scope can be time based or sequence based. The CEDR language has three negation operators, the semantics of which are described informally below. First, for time scope, UNLESS(E1, E2, w) produces an output event when the occurrence of an E1 event is followed by no E2 event in the next w time units. The start time of negation scope is therefore bound to the occurrence of the E1 event.

For the sequence scope, the operator NOT (E, SEQUENCE (E1, . . . ,Ek, w)) is used, where the second parameter of NOT, a sequence operator, is the scope for the non-occurrence of E. The NOT operator produces an output at the occurrence of the sequence event specified by the sequence operator, if there is no occurrence of E between the occurrence of E1 and Ek that contributes to the sequence event. Finally, CANCEL-WHEN (E1, E2) stops the (partial) detection for E1 when an E2 event occurs. Event patterns normally do not “pend” indefinitely; conditions or constraints can be used to cancel the accumulation of state for a pattern (which would otherwise remain to aggregate with future events to generate a composite event). The CANCEL-WHEN construct is employed to describe such constraints. CANCEL-WHEN is a powerful language feature not found in existing event or stream systems. Additionally, negation in CEDR is fully composable with other operators.

Temporal Slicing 506. There are two temporal slicing operators @ and # that correspond to occurrence time and valid time. Users can put slicing operators in the query formulation to customize the bitemporal query output. For example, for Q @ [tₒ₁, tₒ₂) #[tᵥ₁, tᵥ₂), among the tuples in the bitemporal output of query Q, it only outputs tuples valid between tᵥ₁ and tᵥ₂, and that occur at time between tₒ₁ and tₒ₂.

The operator semantics can be specified as follows. Let R be a bitemporal relation.

R@T={e.ID, T, T+1, e.Vₛ, e.Vₑ, e.rt, e.cbt[ ]; e.p)| e is in R, e.Oₛ<=T<e.Oₑ}

R@[T1, T2)=R@T1 union R@T1+1 union . . . union R@T2−1

R#t={(e.ID, e.Oₛ, e.Oₑ, t, t+1, e.rt, e.cbt[ ]; e.p)| e is in R, e.Vₛ<=t<e.Vₑ}

R#[t1, t2)=R#t1 union R#t1+1 union . . . union R#t2−1

For a given query Q, to obtain outputs of Q at occurrence time T, an occurrence time-slice query is issued, denoted as Q as of T. Similarly, to obtain outputs of Q at valid time t, a valid time-slice query can be issued, denoted as Q[t]. In addition to putting a point constraint on occurrence time or valid time, it is possible to restrict both temporal dimensions at the same time, and to put range constraints as well. For example, Q[t1, t2) as of [T1, T2) produces outputs of Q that are valid between valid time t1 and t2, and occur between occurrence time T1 and T2. Similar to the semantics of a temporal interval, which is closed at the beginning and open at the end, the query result is inclusive at the beginning of the range (e.g., t1, T1) and exclusive at the end (e.g., t2, T2). In this notion, Q as of T is short hand for Q[0, ∞) as of [T, T+1), and Q[t] is short hand for Q[t, t+1) as of [0, ∞). For query Q, let its bitemporal output be R. The output of Q[t1, t2) as of [T1, T2) is specified by R@[T1, T2)#[t1, t2).

Following is an example that illustrates the semantics of time-slice queries. Let the output bitemporal table of query Q be given in the following table.

| ID | Oₛ | Oₑ | Vₛ | Vₑ | Rt | . . . |
|---|---|---|---|---|---|---|
| e0 | 1 | 7 | 1 | 10 | 1 | . . . |
| e0 | 7 | ∞ | 1 | 5 | 1 | . . . |

The output of Q as of 3 is the following tuple (e0, 3, 4, 1, 10, 1, . . . ). The output of Q[4] is {(e0, 1, 7, 4, 5, 1, . . . ), (e0, 7, infinity, 4, 5, 1, . . . )}. The output of Q[4,6) as of [3,9) is {(e0, 3, 7, 4, 6, 1, . . . ), (e0, 7, 9, 4, 5, 1, . . . )}.

Value Correlation in the WHERE clause 508. In the query language 500, the semantics of value correlation are defined based on what operators are present in the WHEN clause, by placing the predicates from the WHERE clause into the denotation of the query, a process referred to as predicate injection. Overall, predicate injection for negation is non-trivial, and is simply not handled by many existing systems.

The above operators in the WHEN clause allow the expressing of temporal correlations. Here, the focus is on value correlation, as expressed by the WHERE clause. Given that the expression specified in the WHEN clause can be very complex and may involve multiple levels of negation, it becomes quite difficult to reason about the semantics of value constraints specified in WHERE clause. Thus, the semantics of such correlation are defined based on what operators are present in WHEN clause. The approach takes predicates in the WHERE clause and injects the predicates into the denotation of operators in the WHEN clause. The position of injection depends on whether the operators involve negation or not. In other words, to define the semantics of WHERE clause, the predicates from WHERE clause are placed into the denotation of the query, a process referred to as predicate injection.

For a query WHEN E WHERE P, where E is an event expression and P is a predicate expression specified in WHERE clause, this is denoted as SELECT_{P}(E) when specifying the query semantics. The predicate P is referred to as a selection predicate, since the WHERE clause plays the role of the selection operator in relational operator.

If the top level operator in the WHEN clause is not a negation operator, rewrite the selection predicate P to a disjunctive normal form P=P1 or P2 or . . . or Pk, where each Pi is a conjunction. Then rewrite the whole query as follows.

SELECT_{P}(E)
= SELECT_{P1 or P2 or ... or Pk}(E)
= SELECT_{P1}(E) union SELECT_{P2}(E) union ... union
SELECT_{Pk}(E)

Following is an approach for the case when the top level operator is a negation operator. Beginning with a description of some terminology, there is a negative contributor for each negation operator. For UNLESS(E1, E2, w), E2 is the negative contributor. The definition of negative contributor is transitive: if E2 is a composite expression instead of an event type, all event types involved in this composite expression E2 are negative contributors. Similarly, for NOT(E1, SEQUENCE( . . . )), all event types involved in E1 are negative contributors.

The selection predicate P is a conjunction of a positive component and a negative component. The positive component, denoted as P+, contains all the predicates that do not involve any attribute in the negative contributor of the top level negation operator, and the negative component, denoted as P−, contains the remaining predicates. Note that by definition, in addition to containing predicates referring to attributes in the negative contributor, P− can also refer to attributes in other contributors. Syntactically, P+ and P− are wrapped around with a pair of parentheses in the input query. This prevents the compiler from performing nontrivial rewriting to turn a seemingly unqualified expression into a qualified one. For example, for query WHEN NOT(E1 AS e1, SEQUENCE(E2 AS e2, E3 AS e3, w)) WHERE {e1.y=10 and e1.x=e2.x} and {e2.x=e3.x}, P+ is e2.x=e3.x, and P− is e1.y=10 and e1.x=e2.x.

Following are the semantics for negation predicates in the case when the top level operator is a negation operator. For UNLESS(E1, E2, w), the predicate injection goes as follows.

SELECT_{P+ and P−}( UNLESS(E1, E2, w))
->UNLESS(SELECT_{P+}(E1), SELECT_{P−}(E2), w)

Note the two steps are connected by → instead of =, indicating that this is not a rewrite process where the transformation is bidirectional, but a unidirectional process aimed at injecting predicates into the denotation of operators in right places. Similarly, for NOT(E1, SEQUENCE( . . . )),

SELECT_{P+ and P−}( NOT(E1, SEQUENCE(...)))
-> NOT(SELECT_{P−}(E1), SELECT_{P+}(SEQUENCE(...)))

The process is recursive, and when the process reaches the “leave” case, where the negative contributor of the negation operator under investigation is an event type, instead of a composite event expression, how predicates are injected into the denotation of the negation operator under investigation, is specified. For example, for UNLESS(E1, SELECT_{P−}(E2), w) where E2 is an event type,

```
    UNLESS(E1, SELECT_{P−}(E2), w) ≡ {(e1.rt, e1.Vₛ+w ,
    [e1]; e1.p) | there
does not exist e2, such that (e1.Vₛ < e2.Vₛ < e1.Vₛ + w and
e1, e2 together satisfy P−)}
```

The underlined predicate in the above denotation indicates where P− is injected into the original denotation of UNLESS(E1, E2, w). As a concrete example, consider query,

WHEN NOT(UNLESS(E1 AS e1, E2 AS e2, w),
SEQUENCE(E3 AS e3, E4 AS e4, w’))
WHERE {{e1.a=e2.a} and {ee1.b=e3.b}} and {e3.c=8 or e4.d=10}

The predicate injection process is as follows.

```
    SELECT_{{{e1.a=e2.a} and {e1.b=e3.b}} and {e3.c=8 or
e4.d=10}}(NOT(UNLESS(E1 AS e1, E2 AS e2, w),
SEQUENCE(E3 AS e3, E4 AS
e4, w’))
    -> NOT(SELECT_{{e1.a=e2.a} and
    {e1.b=e3.b}}(UNLESS(E1 AS e1, E2
AS e2, w)), SELECT_{e3.c=8 or e4.d=10}(SEQUENCE(E3 AS e3, E4
AS e4, w’)))
    -> NOT(UNLESS(SELECT_{e1.b=e3.b}(E1 AS e1),
SELECT_{e1.a=e2.a}(E2 AS e2), w), SELECT_{e3.c=8 or
e4.d=10}(SEQUENCE(E3 AS e3, E4 AS e4, w’)))
    -> ...
```

The last step above is omitted, since it gets down to the leave case, where predicates can now be injected into the denotation of operators.

Instance Selection and Consumption 510. In the query language 500, the specification of SC mode is decoupled from operator semantics, and for language composability, SC mode is associated with the input parameters of operators, instead of only base stream events.

Note that in the operator semantics described, a default SC mode is used. In this mode, given multiple instances of the same event type as the input, the system will try to output all possible combinations. Additionally, no instances are consumed after being involved in some outputs. Such an SC mode can be too expensive to implement, since no event can be forgotten, and the size of output stream can be multiplicative with respect to the size of the input streams for a query.

Where a bitemporal model is used, instance selection and consumption are performed on valid time, for each occurrence time instance. What to select and consume at one occurrence time instance does not affect what to select and consume at another occurrence time instance. Thus, to simplify the following description on SC modes, the occurrence time instance T is fixed. That is, given bitemporal input streams, only those events at T are processed, and what to output at T under different SC modes is specified.

Three SC modes can be supported: FIRST, LAST and ALL. FIRST means the earliest (in terms of Vₛ value) instance will be selected for output, and consumed afterwards, LAST means the latest instance will be selected and consumed, and ALL means all existing instances will be selected and consumed.

The SC mode of each parameter for an expression is specified right after each parameter. For example, SEQUENCE(E1 FIRST, E2 FIRST, E3) indicates that the SC modes for E1 and E2 for this SEQUENCE operator are both FIRST. M is denoted to be the SC mode, and so M belongs to {FIRST, LAST, ALL}.

In the absence of a WHERE clause, the semantics of the SEQUENCE operator with SC modes can be specified as follows.

SEQUENCE (E1 M1, E2 M2,..., Ek, w) ≡ {e | e belongs to
SEQUENCE (E1, E2,..., Ek, w) and
CBT_NO_OVERLAP(SEQUENCE (E1 M1, E2 M2,..., Ek,
w)|_{e.Vs-1}, {e}) and e.cbt[1] is in
CBT_SELECT(E1|_{e.Vs-1} , SEQUENCE (E1 M1, E2
M2,..., Ek, w)|_{e.Vs-1}, M1) and ... and e.cbt[k−1] is in
CBT_SELECT(Ek−1|_{e.Vs-1} ,
SEQUENCE (E1 M1, E2 M2,..., Ek, w)|_{e.Vs-1}, Mk−1)}

Here, S|ₜ returns the events in stream S with Vₛ values no later than t. CBT_NO_OVERLAP(set1, set2) is a first order formula that is satisfied iff (if and only if) for all events e1 in set1, for all events e2 in set2, the contributors of e1 and that of e2 do not overlap. The use of CBT_NO_OVERLAP above intuitively says “no contributor in e has participated in any previous output of this expression.” This aligns with a consumption policy of what is selected for output is consumed. CBT_SELECT(candidates, prev_outputs, M) is a function that returns a set of contributor events drawn from candidates, such that they have not participated in any previous outputs, and can be picked according to SC mode M. Formally,

CBT_SELECT(candidates, prev_outputs, M)=OPe.Vₛ{e| e
is in candidates,
CBT_NO_OVERLAP(prev_outputs, {e})}, where OP is MIN if
M is FIRST; OP is
MAX if M is LAST; OP is no-op if M is ALL.

Note that in the above definition of SEQUENCE (E1 M1, E2 M2, . . . , Ek, w), the conjunct for expressing consumption policy, CBT_NO_OVERLAP(SEQUENCE (E1 M1, E2 M2, . . . , Ek, w)|e.Vₛ-1, {e}), can be omitted, because it is implied by the following conjuncts that specify selection policy. However, it is left in the definition for clarity.

Where there is no WHERE clause (value constraints), the semantics of SC modes is straightforward and non-controversial, as was shown above. In the presence of WHERE clause, however, there are a few interesting alternatives to specify the semantics of SC modes. The following example illustrates three possible ways of defining the semantics of SC modes in this case.

The first way to define the semantics of SC modes in the presence of WHERE clause would be to follow and extend the semantics of SC modes in the previous case, where there is no WHERE clause, denoting this semantics as EXTENSION.

A second choice of the semantics of SC modes is to assign weights to the SC modes of different contributors, denoting the second semantics of SC modes as WEIGHT. For the WEIGHT semantics, users are allowed to specify the weights of each SC mode in their query formulation.

A third way to define the semantics of SC modes is denoted as UNION. For a given query, first compute the possible output instances that satisfy the WHERE clause and the WHEN clause without considering the SC modes specified. This set of possible outputs is referred to as base candidate set. Then, with no information regarding the weights of the SC modes for different contributors in the query formulation coming from the user, treat all SC modes in the query formulation equally important, so that no one mode overrides another. Thus, each SC mode is considered separately in instance selection, and then union the results of the instances selected with respect to each SC mode considered separately.

Following is a formal definition of the SEQUENCE operator with SC modes and WHERE clause (represented by selection predicate P) using UNION semantics.

```
    Let the set of potential output instances be POI = {e |
CBT_NO_OVERLAP(SELECT_{P} (SEQUENCE (E1 M1,
E2 M2,..., Ek, w)|e.Vₛ−
1, {e})) and e is in (SELECT_{P}(SEQUENCE (E1, E2,...,
Ek, w))|e.Vₛ−
SELECT_{P}(SEQUENCE (E1 M1, E2 M2,..., Ek, w))|e.Vₛ−1)}.
    SELECT_{P}(SEQUENCE (E1 M1, E2 M2,..., Ek, w)) ≡
INST_SELECT(POI, M1, 1) union INST_SELECT(POI, M2, 2)
union ...
INST_SELECT(POI, Mk−1, k−1).
```

Here INST_SELECT(candidates, M, j) is a function that returns a set of output instances drawn from candidates according to SC mode M on the j-th contributor of event instances in candidates. Formally,

INST_SELECT(candidates, M, j)=OPe.cbt[j].Vₛ (candidates),
where OP is
MIN if M is FIRST; OP is MAX if M is LAST; OP is no-op if M is ALL.

The semantics of other sequencing operators with SC modes and the WHERE clause can be specified in a similar way. In fact, replacing SEQUENCE with ALL above gives the semantics of the ALL operator.

Notice that there is a simple characterization between the EXTENSION semantics and the UNION semantics. The former can be specified by replacing union with intersection in the highlighted definition above. Another observation is that in UNION semantics, for any operator in the query, once some contributor of that operator specifies ALL SC mode, it will in effect override the SC modes of all the other contributors of the same operator to be ALL, due to the union nature in the highlighted definition above. In both WEIGHT and UNION semantics, if the base candidate set is non-empty, the result of applying SC mode is non-empty. This fulfills a requirement for SC mode where it is not overly strong so that all output candidates are eliminated.

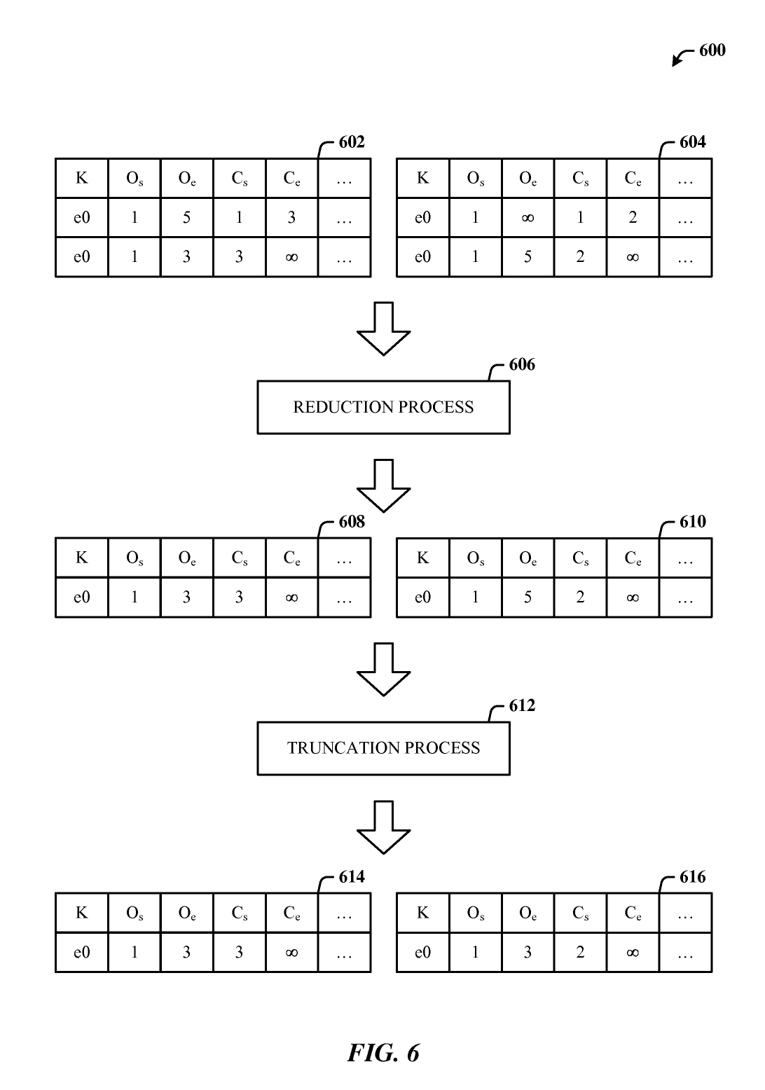

The description of consistency continues with the definitions of terms. First, a canonical history table tₒ time to (occurrence time) is used to describe a notion of stream equivalence. FIG. 6 illustrates a process 600 for converting a non-canonical history table into canonical form. Tables 602 and 604 are examples of non-canonical history tables. Putting the non-canonical tables 602 and 604 into canonical form involves two steps. In the first step, called reduction process 606, for each K, only the entry with earliest Oₑ time is retained. The resulting reduced history tables 608 and 610 for the tables 602 and 604 are shown in FIG. 6. The next step, called truncation process 612, changes any Oₑ value in the table greater than tₒ, to tₒ. If there are any rows where the Oₛ times are greater than tₒ, these rows are removed. The resulting canonical history tables 614 and 616 are shown in FIG. 6.

Next, the notion of canonical history table at tₒ (in place of “to tₒ”) is defined as the canonical history table to tₒ with the rows where the occurrence time interval does not intersect tₒ removed.

Using the above definitions, logical equivalence can be defined as follows:

Definition 1: Two streams S₁ and S₂ are logically equivalent to tₒ (at tₒ) iff, for the associated canonical history tables to tₒ (at tₒ), CH₁ and CH₂, π_{X}(CH₁)=π_{X}(CH₂), where X includes all attributes other than Cₛ and Cₑ.

Intuitively, this definition indicates that two streams are logically equivalent to tₒ (at tₒ) if the streams describe the same logical state of the underlying database to tₒ (at tₒ), regardless of the order in which the state updates arrive. For example, the two streams associated with the two non-canonical tables 602 and 604 are logically equivalent to 3 and at 3.

In order to describe consistency levels, a notion of a synchronization point is defined, which is further based on an annotated form of a history table which introduces an extra column, called Sync. The extra column (Sync) is computed as follows: For insertions Sync=Oₛ; for retractions Sync=Oₑ.

| K | Sync | Oₛ | Oₑ | Cₛ | Cₑ | ... |
|---|---|---|---|---|---|---|
| E0 | 1 | 1 | 10 | 0 | 7 | . . . |
| E0 | 5 | 1 | 5 | 7 | 10 | . . . |

The intuition behind the Sync column is that the column is the latest occurrence time that the insertion/retraction is seen in order to avoid inserting/deleting the tuple at an incorrect time.

Following is the definition of a synchronization point (or “sync” point):

Definition 2: A sync point with respect to an annotated history (AH) table AH is a pair of occurrence time and CEDR time (tₒ, T), such that for each tuple e in AH, either e.Cₛ<=T and e.Sync<=tₒ, or e.Cₛ>T and e.Sync>tₒ.

Intuitively, a sync point is a point in time in the stream where exactly the minimal set of state changes which can affect the bitemporal historic state up to occurrence time tₒ is seen.

Following are the definitions for three levels of consistency: strong, middle, and weak.

Definition 3: A standing query supports the strong consistency level iff: 1) for any two logically equivalent input streams S₁ and S₂, for sync points (tₒ, T_{S1}), (tₒ, T_{S2}) in the two output streams, the query output streams at these sync points are logically equivalent to tₒ at CEDR times T_{S1} and T_{S2}, and 2) for each entry E in the annotated output history table, there exists a sync point (E.Sync, E.Cₛ).

Intuitively, this definition says that a standing query supports strong consistency iff any two logically equivalent inputs produce exactly the same output state modifications, although there may be different delivery latency. Note that in order for a system to support this notion of consistency, the system utilizes “hints” that bound the effect of future state updates with respect to occurrence time. In addition, for n-ary operators, any combination of input streams can be substituted with logically equivalent streams in this definition. This is also true for the other consistency definitions and will not be described further.

Definition 4: A standing query supports the middle consistency level iff for any two logically equivalent input streams S₁ and S₂, for sync points (tₒ, T_{S1}), (tₒ, T_{S2}) in the two output streams, the query output streams at these sync points are logically equivalent to tₒ at CEDR times T_{S1} and T_{S2}.

The definition of the middle level of consistency is almost the same as the high level. The only difference is that not every event is a sync point. Intuitively, this definition allows for the retraction of optimistic state at times in between sync points. Therefore, this notion of consistency allows early output in an optimistic manner.

Definition 5: A standing query supports the weak consistency level iff for any two logically equivalent input streams S₁ and S₂, for sync points (tₒ, T_{S1}), (tₒ, T_{S2}) in the two output streams, the query output streams at these sync points are logically equivalent at tₒ at CEDR times T_{S1} and T_{S2}.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

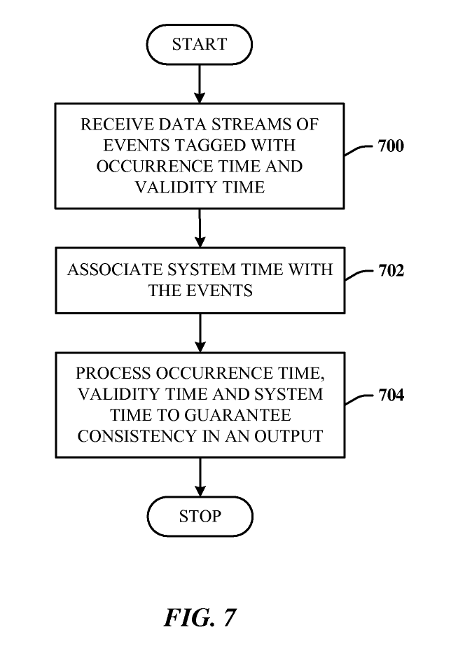

FIG. 7 illustrates a computer-implemented method of events processing. At 700, data streams of events tagged with occurrence time and validity time are received. At 702, system time is associated with the events. At 704, the occurrence time, validity time, and system time of the events are processed to guarantee consistency in an output.

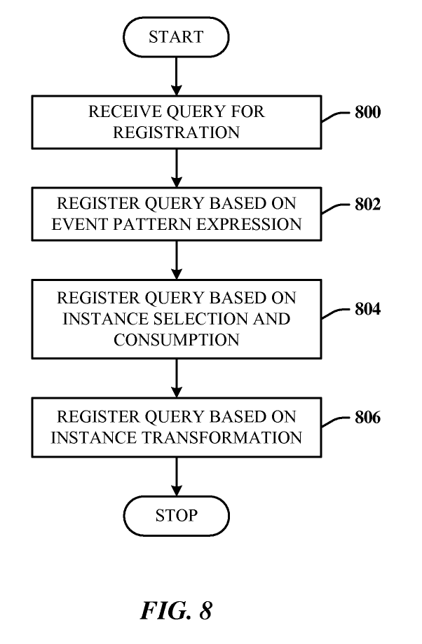

FIG. 8 illustrates a method of registering an event query. At 800, a query is received for processing. At 802, the query is registered based on an event pattern expression. At 804, the query is registered based on instance selection and consumption. At 806, the query is registered based on instance transformation.

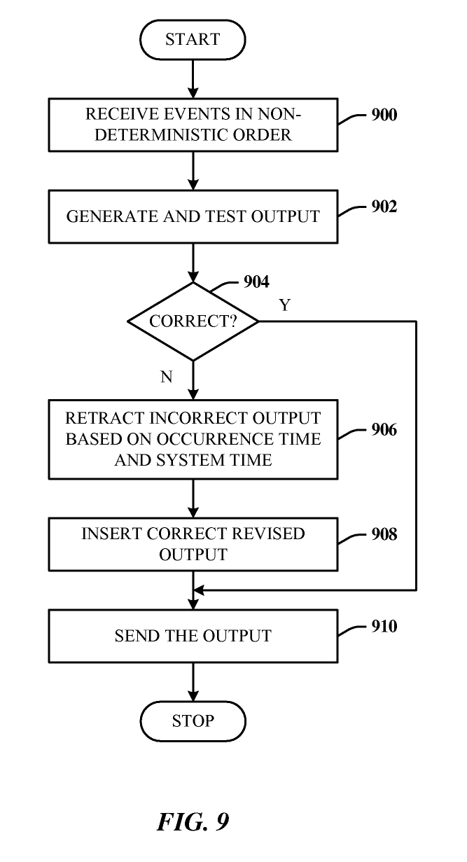

FIG. 9 illustrates a method of correcting incorrect output. At 900, events are received in a non-deterministic order. At 902, based on the events, the output is generated and tested for correctness. At 904, if the output is not correct, flow is to 906 where the incorrect output is retracted based on occurrence time and system time. At 908, the correct revised output is inserted. At 910, the corrected output is sent. Alternatively, if the output is correct at 904, flow is directly to 910 to send the output as is.

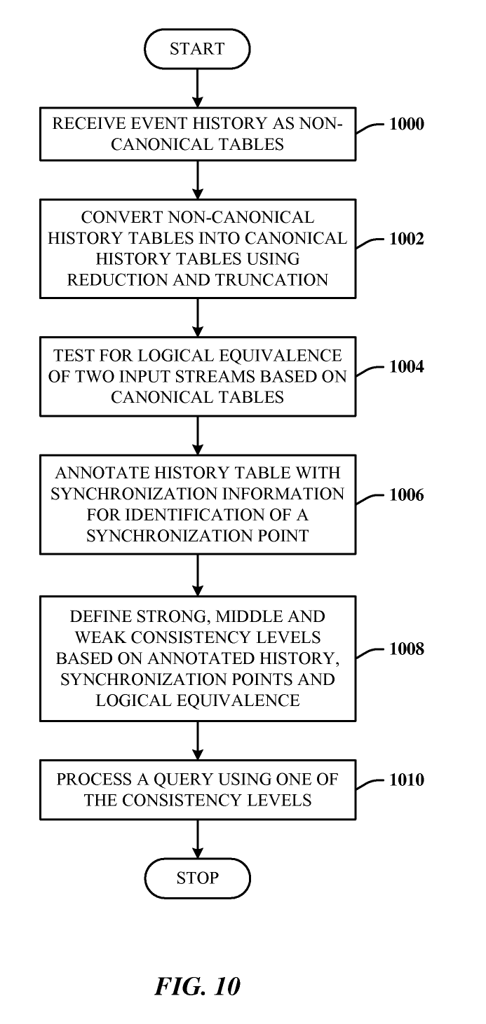

FIG. 10 illustrates a method of defining levels of consistency for query processing. At 1000, event history is received in the form of non-canonical history tables. At 1002, the non-canonical tables are converted to canonical history tables using reduction and truncation. At 1004, logical equivalence of two input streams is tested based on the canonical history tables. At 1006, a history table is annotated with synchronization information for identification of a synchronization point. At 1008, strong, middle and weak consistency levels are defined based on the annotated history, synchronization points, and logical equivalence. At 1010, a query is processed to generate an output using one of the consistency levels.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

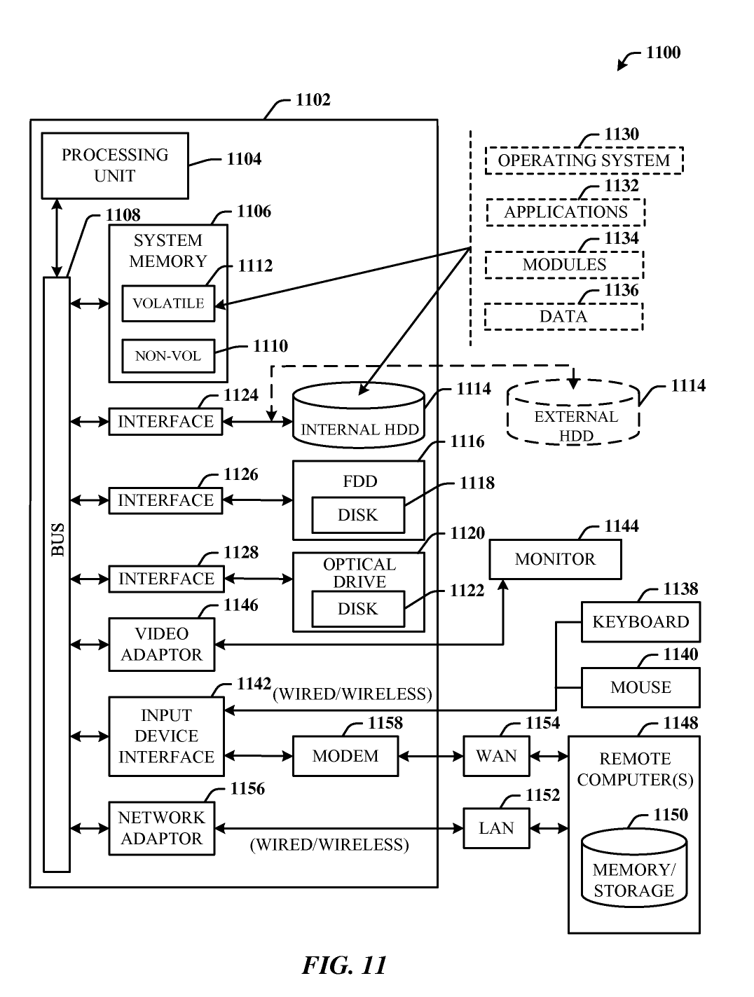

Referring now to FIG. 11, there is illustrated a block diagram of a computing system 1100 operable to execute event stream processing in accordance with the disclosed architecture. In order to provide additional context for various aspects thereof, FIG. 11 and the following discussion are intended to provide a brief, general description of a suitable computing system 1100 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 11, the exemplary computing system 1100 for implementing various aspects includes a computer 1102 having a processing unit 1104, a system memory 1106 and a system bus 1108. The system bus 1108 provides an interface for system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 can include non-volatile memory (NON-VOL) 1110 and/or volatile memory 1112 (e.g., random access memory (RAM)). A basic input/output system (BIOS) can be stored in the non-volatile memory 1110 (e.g., ROM, EPROM, EEPROM, etc.), which BIOS stores the basic routines that help to transfer information between elements within the computer 1102, such as during start-up. The volatile memory 1112 can also include a high-speed RAM such as static RAM for caching data.

The computer 1102 further includes an internal hard disk drive (HDD) 1114 (e.g., EIDE, SATA), which internal HDD 1114 may also be configured for external use in a suitable chassis, a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as a DVD). The HDD 1114, FDD 1116 and optical disk drive 1120 can be connected to the system bus 1108 by a HDD interface 1124, an FDD interface 1126 and an optical drive interface 1128, respectively. The HDD interface 1124 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 1112, including an operating system 1130, one or more application programs 1132, other program modules 1134, and program data 1136. The one or more application programs 1132, other program modules 1134, and program data 1136 can include the event receiving component 102, consistency component 108, event streams 106 and 204, stream processor 206, query subscriber 208, bitemporal history table 300, tritemporal history table 400, query language 500, reduction process 606 and truncation process 612, for example.

All or portions of the operating system, applications, modules, and/or data can also be cached in the volatile memory 1112. It is to be appreciated that the disclosed architecture can be implemented with various commercially available operating systems or combinations of operating systems.

A user can enter commands and information into the computer 1102 through one or more wire/wireless input devices, for example, a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces such as a parallel port, IEEE 1394 serial port, a game port, a USB port, an IR interface, etc.

A monitor 1144 or other type of display device is also connected to the system bus 1108 via an interface, such as a video adaptor 1146. In addition to the monitor 1144, a computer typically includes other peripheral output devices (not shown), such as speakers, printers, etc.

The computer 1102 may operate in a networked environment using logical connections via wire and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wire/wireless connectivity to a local area network (LAN) 1152 and/or larger networks, for example, a wide area network (WAN) 1154. Such LAN and WAN networking environments are commonplace in offices and companies, and facilitate enterprise-wide computer networks, such as intranets, all of which may connect to a global communications network, for example, the Internet.

When used in a LAN networking environment, the computer 1102 is connected to the LAN 1152 through a wire and/or wireless communication network interface or adaptor 1156. The adaptor 1156 can facilitate wire and/or wireless communications to the LAN 1152, which may also include a wireless access point disposed thereon for communicating with the wireless functionality of the adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wire and/or wireless device, is connected to the system bus 1108 via the input device interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi (or Wireless Fidelity) and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3 or Ethernet).

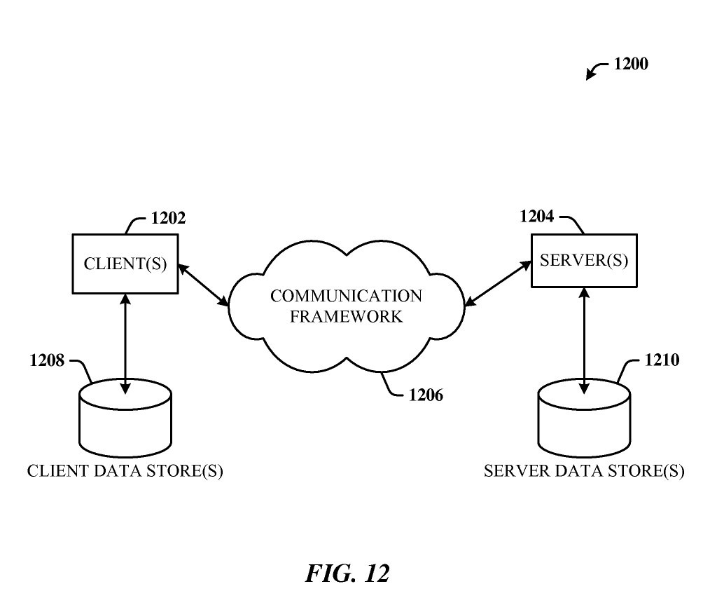

Referring now to FIG. 12, there is illustrated a schematic block diagram of an exemplary computing environment 1200 for consistent event stream processing. The environment 1200 includes one or more client(s) 1202. The client(s) 1202 can be hardware and/or software (e.g., threads, processes, computing devices). The client(s) 1202 can house cookie(s) and/or associated contextual information, for example.

The environment 1200 also includes one or more server(s) 1204. The server(s) 1204 can also be hardware and/or software (e.g., threads, processes, computing devices). The servers 1204 can house threads to perform transformations by employing the architecture, for example. One possible communication between a client 1202 and a server 1204 can be in the form of a data packet adapted to be transmitted between two or more computer processes. The data packet may include a cookie and/or associated contextual information, for example. The environment 1200 includes a communication framework 1206 (e.g., a global communication network such as the Internet) that can be employed to facilitate communications between the client(s) 1202 and the server(s) 1204.

Communications can be facilitated via a wire (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

The clients 1202 can include the sources 106, the devices 202, and the subscriber 208, while the servers 1204 can include the stream processor 206.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented event processing system, comprising:
an event receiving component for receiving events from streaming sources, the events tagged with occurrence time and validity time; and
a consistency component for processing the occurrence time and validity time of the events to guarantee consistency in an output.

2. The system of claim 1, wherein the receiving component associates a system time with each event and the consistency component uses the system time to generate the consistency in the output.

3. The system of claim 1, wherein the consistency component retracts an incorrect output and inserts a corrected output.

4. The system of claim 1, wherein the validity time is a validity interval that is changed by an event provider.

5. The system of claim 1, wherein the consistency component processes a query received from a subscriber to generate the output.

6. The system of claim 1, wherein the consistency component guarantees consistency in the output based on conversion of non-canonical history tables into canonical form.

7. The system of claim 1, wherein the consistency component guarantees consistency in the output according to operation at one of multiple levels of consistency.

8. The system of claim 1, wherein the consistency component guarantees consistency in the output based on a synchronization point that defines a latest occurrence time at which correction in the output can be made.

9. The system of claim 1, wherein the consistency component guarantees consistency in the output based on logical equivalence between two input streams of events.

10. A computer-implemented method of events processing, comprising:
receiving data streams of events tagged with occurrence time and validity time;
associating system time with the events; and
processing the occurrence time, validity time, and system time of the events to guarantee consistency in an output.

11. The method of claim 10, further comprising synthesizing the events based on ordering of previous events.

12. The method of claim 10, further comprising registering a query of the events based on an event pattern expression.

13. The method of claim 10, further comprising registering a query of the events based on an instance selection and consumption mode.

14. The method of claim 10, further comprising registering a query of the events based on instance transformation of the events using aggregation, attribute projection or computation of a new function.

15. The method of claim 10, further comprising customizing the output using temporal slicing on the occurrence time and the validity time.

16. The method of claim 10, further comprising associating instance selection and consumption with input parameters of operators on the events.

17. The method of claim 10, further comprising tracking non-occurrence of an expected event and imposing conditions that cancel accumulation of state for an event pattern.

18. The method of claim 10, further comprising performing value correlation based on predicate injection.

19. The method of claim 10, further comprising correcting an incorrect output and inserting a new correct output based on the occurrence time and the system time.

20. A computer-implemented system, comprising:
computer-implemented means for receiving data streams of events tagged with occurrence time and validity time;
computer-implemented means for associating system time with the events; and
computer-implemented means for processing the occurrence time, validity time, and system time of the events to guarantee consistency in an output.
